(19) United States
(12) Patent Application Publication
(10) Pub. No.: US 2019/0294035 A1
(43) Pub. Date: Sep. 26, 2019

(54) LASER PROJECTION DEVICE

(71) Applicant: QISDA CORPORATION, Taoyuan City (TW)

(72) Inventors: Chih-Shiung Chien, Taoyuan City (TW); Ming-Kuen Lin, Taoyuan City (TW); Tsung-Hsun Wu, Taoyuan City (TW)

(21) Appl. No.: 16/355,863

(22) Filed: Mar. 18, 2019

(30) Foreign Application Priority Data
Mar. 23, 2018 (CN) 201810243927.6

(51) Int. Cl. G03B 21/20; G02B 7/04

(52) U.S. Cl. CPC G03B 21/208; G02B 7/04; G03B 21/204

(57) ABSTRACT

A laser projection device includes a condenser, a wavelength transforming component and a laser array. The wavelength transforming component is disposed adjacent to the condenser. The laser array includes a plurality of laser units, and each laser unit includes a laser source and a lens. The laser source is adapted to output a laser beam. The lens is disposed adjacent to and corresponds to the laser source. The lens is adapted to transform the laser beam into a unparallel beam and further to transmit the unparallel beam to the condenser for projecting onto the wavelength transforming component.

### BACKGROUND OF THE INVENTION

### 1. Field of the Invention

The present invention relates to a laser projection device, and more particularly, to a laser projection device capable of increasing excitation efficiency.

### 2. Description of the Prior Art

The laser projector utilizes the laser source to irradiate fluorescent material, such as phosphor powder. Energy of the laser beam is absorbed by the fluorescent material and visible light with various colors can be emitted accordingly. The conventional laser projector disposes the collimator lens module before the laser source, and the collimator lens module transforms the divergent laser beam emitted by the laser source into a parallel beam. The parallel beam is transmitted to the fluorescent material by the condenser lens. However, a spot projected onto the fluorescent material by the conventional laser projector has small dimensions, so that the fluorescent material may be heated over the transition temperature and the fluorescent material cannot provide preferred excitation efficiency. A common solution may utilize a diffuser to enlarge the spot, but energy distribution of the excited visible light is affected and a projection efficiency of the laser projector is decreased accordingly. Thus, design of a laser projector capable of increasing excitation efficiency is an important issue in the optical apparatus industry.

### SUMMARY OF THE INVENTION

The present invention provides a laser projection device capable of increasing excitation efficiency for solving above drawbacks.

According to the claimed invention, a laser projection device includes a condenser, a wavelength transforming and a laser array. The wavelength transforming component is disposed adjacent to the condenser. The laser array includes a plurality of laser units. Each laser unit includes a laser source and a lens. The laser source is adapted to emit a laser beam. The lens is disposed adjacent to and corresponds to the laser source. The lens is adapted to transform the laser beam into an unparallel beam, and further to transmit the unparallel beam to the condenser for projecting onto the wavelength transforming component.

According to the claimed invention, the lens has a first focal point, and the laser source is disposed on a first position different from the first focal point. Further, the condenser has a second focal point, and the wavelength transforming component is disposed on a second position different from the second focal point.

The laser projection device of the present invention can match one lens with each laser source, the said lens can transform the laser beam emitted by the laser source into the unparallel beam for forming the enlarged and blurred image; the said image can be projected onto the wavelength transforming component via the condenser for forming the enlarged and uniform spot, so as to increase the excitation efficiency of the wavelength transforming component. The laser projection device can vary the relative distance between the lens and the laser source or the relative distance between the condenser and the wavelength transforming component to transform the original laser beam into the convergent or divergent unparallel beam. Adjustment of the relative distance can be executed by utilizing the movable component to move the lens or the laser source, or utilizing the supporter to move the condenser or the wavelength transforming component.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 0.1 is a diagram of a laser projection device according to a first embodiment of the present invention.

FIG. 2 is a diagram of a laser projection device according to a second embodiment of the present invention.

FIG. 3 is a diagram of the unparallel beam formed by the laser unit according to the embodiment of the present invention.

FIG. 4 and FIG. 5 are diagrams of optical energy distributed over different axes of the wavelength transforming component according to the embodiment of the present invention.

FIG. 6 is an enlarged diagram of the condenser and the wavelength transforming component according to the embodiment of the present invention.

### DETAILED DESCRIPTION

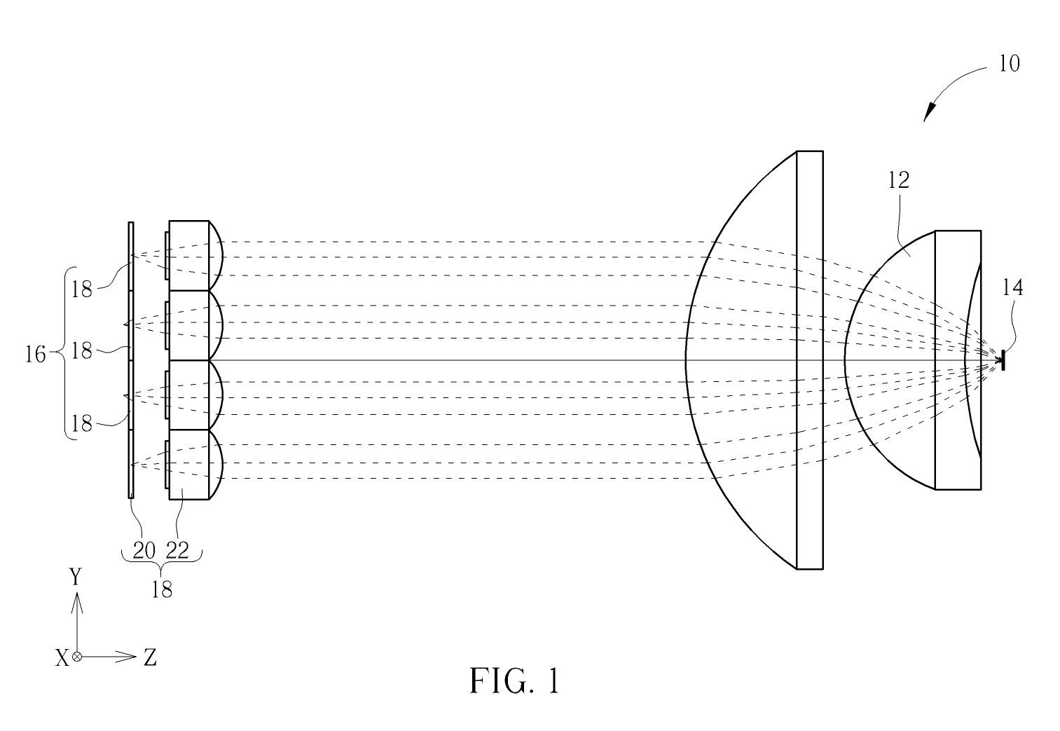

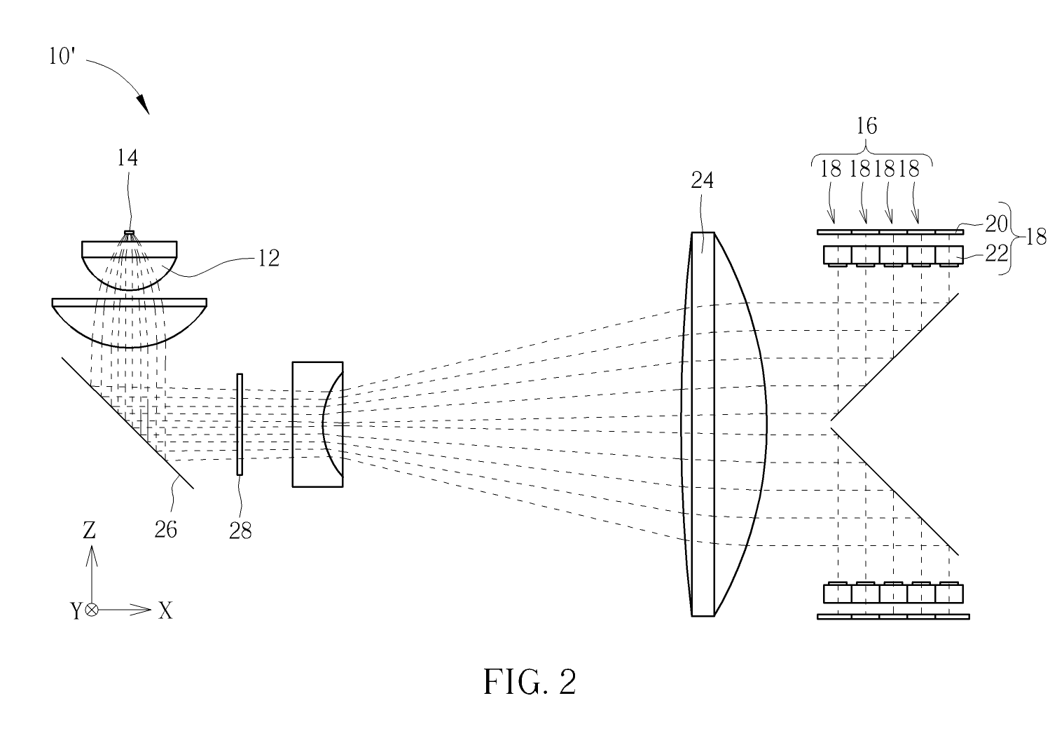

Please refer to FIG. 1 and FIG. 2. FIG. 0.1 is a diagram of a laser projection device 10 according to a first embodiment of the present invention. FIG. 2 is a diagram of a laser projection device 10′ according to a second embodiment of the present invention. The laser projection device 10 can include a condenser 12, a wavelength transforming component 14 and a laser array 16. The condenser 12 can be disposed between the wavelength transforming component 14 and the laser array 16, and used to transmit a beam emitted by the laser array to the wavelength transforming component 14. The wavelength transforming component 14 may have fluorescent material or quantum dot material, which can transform the beam from certain specific color to another. The laser array 16 can include a plurality of laser units 18. Each laser unit 18 can have a laser source 20 and a lens 22. The laser source 20 can generate a laser beam. The lens 22 is disposed adjacent to and corresponds to the laser source 20, which means each laser source 20 may match with a corresponding lens 22. The lens 22 is used to transform the laser beam into an unparallel beam, and the unparallel beam is transmitted to the condenser 12 and then projected onto the wavelength transforming component 14.

In the second embodiment, elements having the same numerals as one of the first embodiment have the same structures and functions, and a detailed description is omitted herein for simplicity. Difference between the two embodiments is that the second embodiment has a large amount of the laser units 18, so the laser projection device 10′ can optionally include an afocal lens module 24 disposed between the laser array 16 and the condenser 12. The afocal lens module 24 is used to vary a dimension of the laser beam emitted by the laser array 16 in space, and therefore the laser beam can be transmitted into the condenser 12. The laser projection device 10′ can further include a reflector 26 and a diffuser 28 disposed between the afocal lens module 24 and the condenser 12. The reflector 26 can be used to change a transmission direction of the laser beam emitted by the laser array 16. The diffuser 28 can be used to uniform the laser beam.

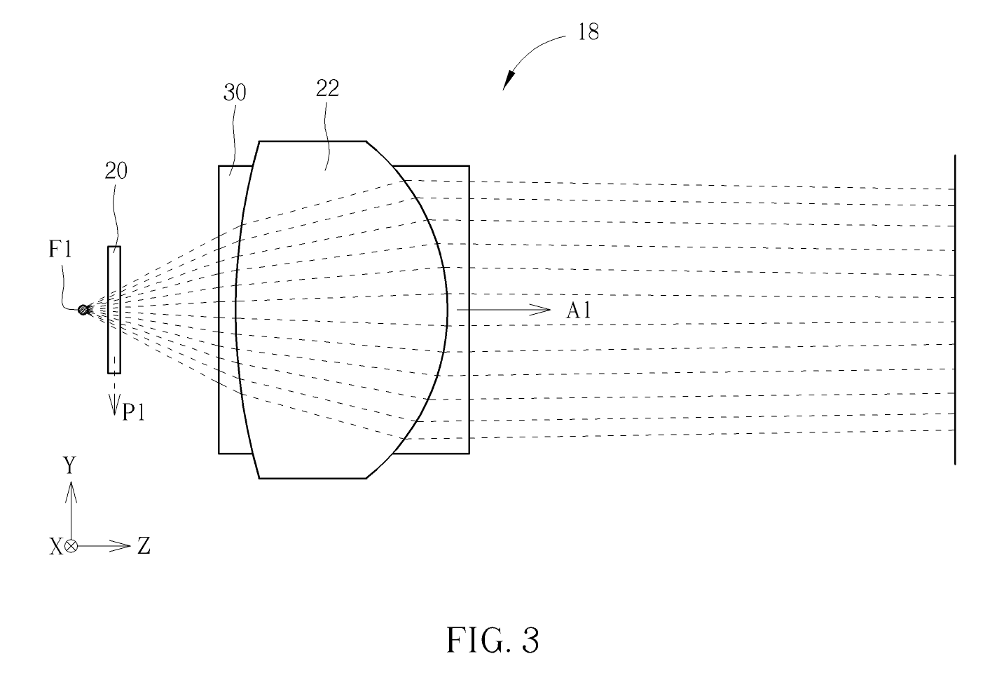

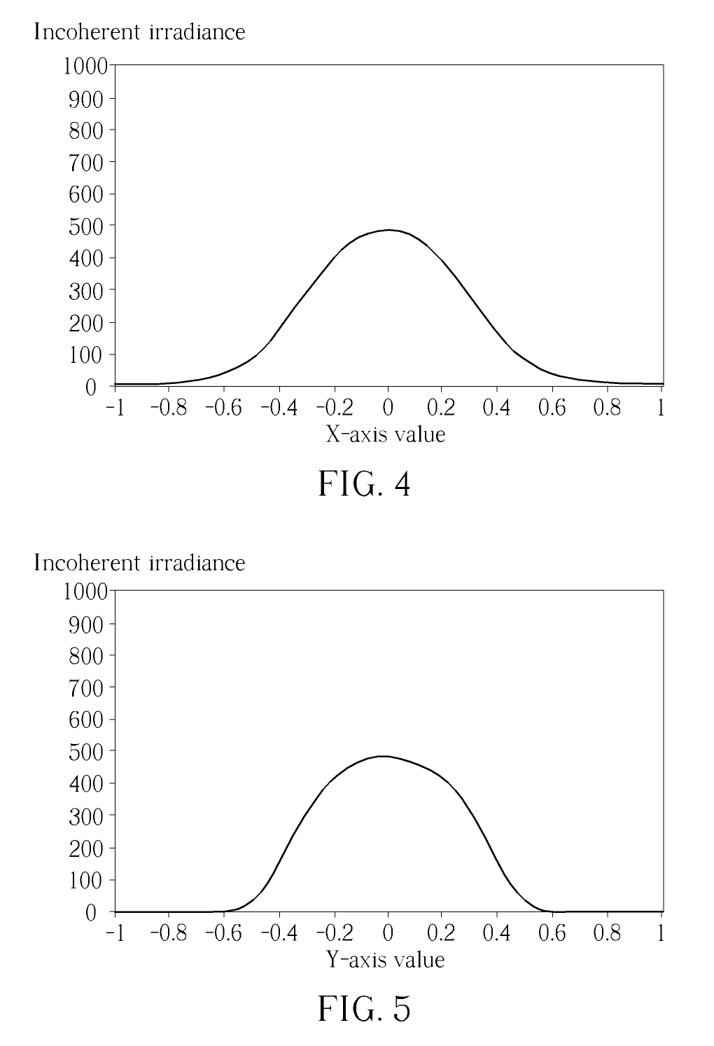

Please refer to FIG. 3 to FIG. 5. FIG. 3 is a diagram of the unparallel beam formed by the laser unit 18 according to the embodiment of the present invention. FIG. 4 and FIG. 5 are diagrams of optical energy distributed over different axes of the wavelength transforming component 14 according to the embodiment of the present invention. As shown in FIG. 3, the laser source 20 is disposed on a defocused position of the lens 22; that is to say, the lens 22 has a first focal point F1, and the laser source 20 is disposed on a first position P1 different from the first focal point F1. A shape of the lens 22 is not limited to the double convex lens or the plano-convex lens mentioned in figures of the present invention. Any optical component or a related combination capable of transforming the laser beam emitted by the laser source 20 into the unparallel beam via convergence or divergence belongs to a scope of the present invention.

For defocusing design of the laser unit 18, the laser unit 18 may optionally include a movable component 30 configured to movably hold the lens 22, so as to vary a relative distance between the lens 22 and the laser source 20. The movable component 30 can be moved along an optical axis A1 of the lens 22 forward and backward, and the first focal point F1 can misalign the first position P1 in accordance with position variation of the lens 22; parameters (such as a projection range or energy concentration) of the laser beam are adjusted to form the unparallel beam, and optical energy distribution over the wavelength transforming component 14 can be uniform accordingly, as shown in FIG. 4 and FIG. 5. It should be mentioned that the present invention further can utilize the movable component to hold the laser source 20. Any arrangement capable of varying the relative distance between the lens 22 and the laser source 20 belongs to the defocusing design demand of the laser unit 18 in the present invention.

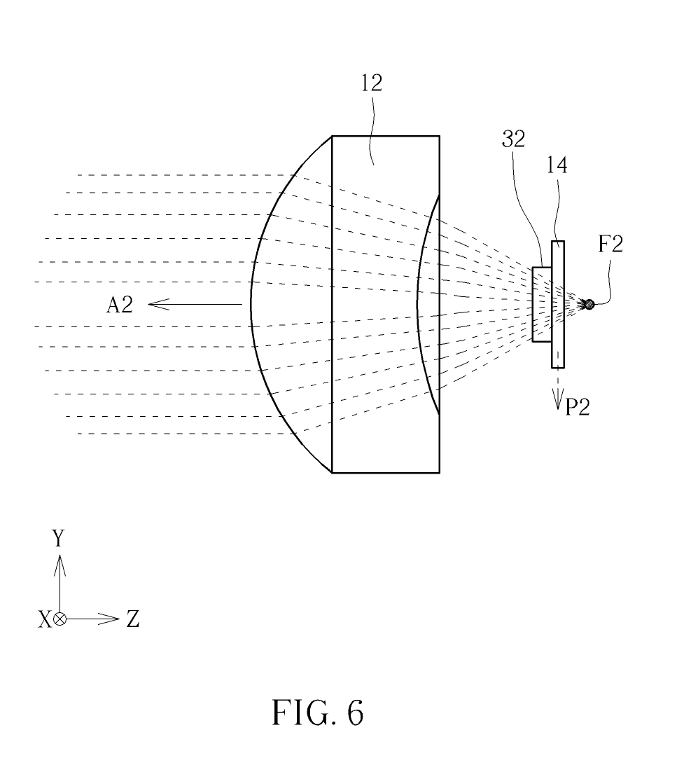

Please refer to FIG. 6. FIG. 6 is an enlarged diagram of the condenser 12 and the wavelength transforming component 14 according to the embodiment of the present invention. The wavelength transforming component 14 is disposed on a defocusing position of the condenser 12; as mentioned above, the condenser 12 has a second focal point F2, and the wavelength transforming component 14 is disposed on a second position P2 different from the second focal point F2. The present invention can dispose the wavelength transforming component 14 on the supporter 32, and the supporter 32 can be moved along an optical axis A2 of the condenser 12 to vary a relative distance between the condenser 12 and the wavelength transforming component 14, so as to enlarge an image generated by the laser beam projected onto the wavelength transforming component 14. The supporter of the present invention further can be used to support and move the condenser 12 for varying the relative distance between the condenser 12 and the wavelength transforming component 14. Therefore, defocusing design of the laser unit 18 and the condenser 12 can form an enlarged and uniform spot on the wavelength transforming component 14, so as to decrease temperature of the wavelength transforming component 14 and increase its excitation efficiency accordingly.

In conclusion, the laser projection device of the present invention can match one lens with each laser source, the said lens can transform the laser beam emitted by the laser source into the unparallel beam for forming the enlarged and blurred image; the said image can be projected onto the wavelength transforming component via the condenser for forming the enlarged and uniform spot, so as to increase the excitation efficiency of the wavelength transforming component. The laser projection device can vary the relative distance between the lens and the laser source or the relative distance between the condenser and the wavelength transforming component to transform the original laser beam into the convergent or divergent unparallel beam. Adjustment of the relative distance can be executed by utilizing the movable component to move the lens or the laser source, or utilizing the supporter to move the condenser or the wavelength transforming component.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A laser projection device, comprising:
a condenser;
a wavelength transforming component disposed adjacent to the condenser; and
a laser array comprising a plurality of laser units, and each laser unit comprising:
a laser source adapted to emit a laser beam; and
a lens disposed adjacent to and corresponds to the laser source, the lens being adapted to transform the laser beam into an unparallel beam and further to transmit the unparallel beam to the condenser for projecting onto the wavelength transforming component.

2. The laser projection device of claim 1, wherein the lens has a first focal point, the laser source is disposed on a first position different from the first focal point.

3. The laser projection device of claim 1, wherein the laser beam is converged or diverged to form the unparallel beam via the lens.

4. The laser projection device of claim 1, wherein the each laser unit further comprises a movable component configured to hold the lens for varying a relative distance between the lens and the laser source.

5. The laser projection device of claim 1, wherein the condenser has a second focal point, the wavelength transforming component is disposed on a second position different from the second focal point.

6. The laser projection device of claim 1, further comprising:
a supporter whereon the wavelength transforming component is disposed, a relative distance between the supporter and the condenser being varied to enlarge an image generated by the laser beam projected onto the wavelength transforming component.

7. The laser projection device of claim 6, wherein the condenser comprises an optical axis, the supporter is moved along the optical axis to vary the relative distance.

8. The laser projection device of claim 1, further comprising:
an afocal lens module disposed between the laser array and the condenser and adapted to vary a dimension of the laser beam in space.
